(19) United States
(12) Patent Application Publication
(10) Pub. No.: US 2009/0039141 A1
(43) Pub. Date: Feb. 12, 2009

(54) BONDING WIRE CLEANING UNIT AND METHOD OF WIRE BONDING USING THE SAME

(75) Inventors: Horst Clauberg, Warminster, PA (US); Ronald J. Focia, Stevens, PA (US); David T. Beatson, Kennett Square, PA (US); Kenneth Kyle Dury, Kihei, HI (US)

Correspondence Address: KULICKE AND SOFFA INDUSTRIES, INC., 1005 VIRGINIA DRIVE, FORT WASHINGTON, PA, 19034, US

(73) Assignee: KULICKE AND SOFFA INDUSTRIES, INC., Fort Washington, PA (US)

(21) Appl. No.: 12/250,369

(22) Filed: Oct. 13, 2008

Related U.S. Application Data
(63) Continuation of application No. 11/096,140, filed on Mar. 31, 2005.

(51) Int. Cl. B23K 1/20; B23K 3/08

(52) U.S. Cl. 228/205; 228/18

(57) ABSTRACT

A wire cleaning system for cleaning wire configured to be wirebonded is provided. The wire cleaning system includes a chamber through which a wire configured to be wirebonded extends prior to the wire being wirebonded. The wire cleaning system also includes an energy source for removing contamination from the wire in the chamber prior to the wire being wirebonded.

### CROSS REFERENCE OF RELATED APPLICATION

This is a continuation of U.S. patent application Ser. No. 11/096,140, filed Mar. 21, 2005 (entitled “BONDING WIRE CLEANING UNIT AND METHOD OF WIRE BONDING USING THE SAME”), which is incorporated by reference in its entirety.

### FIELD OF THE INVENTION

The present invention relates to a system for cleaning a fine wire prior to bond interconnection and, more particularly, to a system for integrally cleaning the fine wire just prior to the wire bonding process to improve the wire bonded interconnections.

### BACKGROUND OF THE INVENTION

Automatic wire bonders that employ computer controls are known and described in U.S. Pat. Nos. 4,266,710 and 4,239,144 assigned to Kulicke and Soffa Industries, Inc., the same assignee as the present invention, and enable completion of wire interconnections at high speed. Typically, the fine wire used to make such interconnections is not cleaned as part of the bonding process, and as such, contaminants on the surface of the wire may degrade the bond strength of the ball bonds and/or wedge bonds produced by the bonding tool. For example, because the surface of the fine wire is coated with a lubricant to ensure that the fine wire does not stick to itself and, thus, does not break during unspooling, contamination in the ball bonds and/or the wedge bonds may occur and may reduce bond strengths due at least in part to this lubricant. Moreover, because the contamination (e.g., the lubricant) passes through a capillary of the wire bonding tool of the wire bonder, a portion of the contamination may contaminate the capillary causing more frequent replacement and/or cleaning of the capillary.

Semiconductor devices (e.g., discrete devices such as dies and chips, VLSI devices, etc.) are becoming more dense and are employing a greater number of lead out pads (i.e., electrodes of the VLSI devices) that must be wire bonded to lead connections on carriers or packages. That is the wire bonding includes ball bonding of the fine wire to the lead out pad of the semiconductor device and bonding of the fine wire to the lead connections on the carriers or packages. As a result of the more dense devices, the lead out pads and the lead connections are becoming smaller, and as such, contamination in the bonds produced by the ball bonding and wedge bonding process is becoming a more significant problem. Further, contamination of the wire may also interfere with the ball formation process, resulting in inconsistent ball size/shape.

Although traditionally gold has been the material of choice for the bonding wire, the use of copper bonding wire (and other metals) is increasing. Unlike gold, the surface of copper wire is usually contaminated by copper oxides. These oxides adversely affect the bond formation at first and second bond.

Thus, it would be desirable to provide a system and method for reducing contamination of wire bonds.

### SUMMARY OF THE INVENTION

According to an exemplary embodiment of the present invention, a wire cleaning system for cleaning wire configured to be wirebonded is provided. The wire cleaning system includes a chamber through which a wire configured to be wirebonded extends prior to the wire being wirebonded. The wire cleaning system also includes an energy source for removing contamination from the wire in the chamber prior to the wire being wirebonded.

According to another exemplary embodiment of the present invention, a wire bonding machine is provided. The wire bonding machine includes a wire bonding tool configured to receive a wire to be bonded to a location. The wire bonding machine also includes a wire cleaning system for cleaning the wire prior to the wire being bonded to the location. The wire cleaning system includes: (1) a chamber through which the wire extends prior to the wire being bonded to the location, and (2) an energy source for removing contamination from the wire in the chamber prior to the wire being bonded to the location.

According to yet another exemplary embodiment of the present invention, a method of bonding a wire between a conductive pad of a semiconductor device and a conductive pad of a substrate is provided. The method includes removing contamination from the wire prior to bonding the wire between the conductive pad of the semiconductor device and the conductive pad of the substrate. The method also includes bonding the wire between the conductive pad of the semiconductor device and the conductive pad of the substrate.

### BRIEF DESCRIPTION OF THE DRAWINGS

Although the invention is illustrated and described herein with reference to specific embodiments, the invention is not intended to be limited to the details shown. Rather, various modifications may be made in the details within the scope and range of equivalents of the claims and without departing from the invention.

It is emphasized that, according to common practice, the various features of the drawings are not to scale. On the contrary, the dimensions of the various features are arbitrarily expanded or reduced for clarity. Included in the drawings are the following figures:

FIG. 1 is a schematic view illustrating a supply mechanism of a wire bonder 100 according to an exemplary embodiment of the present invention;

FIG. 2 is a partial top plan view of a semiconductor die 200 and substrate 210 that may be bonded by wire bonder 100 in accordance with an exemplary embodiment of the present invention;

FIG. 3 is a schematic view illustrating a compensation unit 190 in accordance with an exemplary embodiment of the present invention;

FIG. 4 is a schematic view illustrating another compensation unit 195 in accordance with an exemplary embodiment of the present invention;

FIG. 5 is a schematic view illustrating a cleaning unit 300 in accordance with an exemplary embodiment of the present invention;

FIG. 6 is a schematic view illustrating another cleaning unit 400 in accordance with an exemplary embodiment of the present invention;

FIG. 7 is a schematic view illustrating yet another cleaning unit 500 in accordance with an exemplary embodiment of the present invention;

FIG. 8 is a schematic view illustrating yet another cleaning unit 600 in accordance with an exemplary embodiment of the present invention; and

FIG. 9 is a schematic view illustrating yet another cleaning unit 700 in accordance with an exemplary embodiment of the present invention.

### DETAILED DESCRIPTION OF THE INVENTION

In the figures like numerals represent like features.

As used herein, the term “chamber” is intended to refer to any structure enclosed or otherwise that is used in connection with an energy source and a wire. The chamber may be a separate unit or be integral with a wirebonder. For example, a bonding tool may include such a chamber. The chamber may at least partially enclose the wire which passes through the chamber or the chamber may be any structure used in connection with the energy source to remove contamination from the wire, for example, a structure to reflect light from an ultraviolet light energy source towards a wire, a structure to facilitate plasma discharge from a plasma discharge energy source, and/or a structure to facilitate plasma jet discharge from a plasma jet energy source, among others.

As used herein, the terms “contaminant” and “contamination” are intended to refer to any undesirable substance present on a bonding wire. For example, such contaminants include lubricants, organic contaminants, inorganic contaminants, oxides, etc.

As used herein, the term substrate refers to any structure to which a semiconductor device is wire bonded, including but not limited to printed circuit boards, leadframes, cards, etc.

As used herein, the term semiconductor device refers to any of a number of devices including semiconductor dies, semiconductor chips, VLSI devices, integrated circuits, etc., and any other device intended to be wire bonded to a substrate.

As used herein, the term conductive pad refers to any contact including contacts integrated as part of a semiconductor device or a substrate to which a wire is bonded.

As used herein, the term energy source refers to any energy source that may be used remove contaminants from a wire. Exemplary energy sources disclosed herein include a plasma discharge energy source, an ultraviolet light energy source, and a plasma jet energy source.

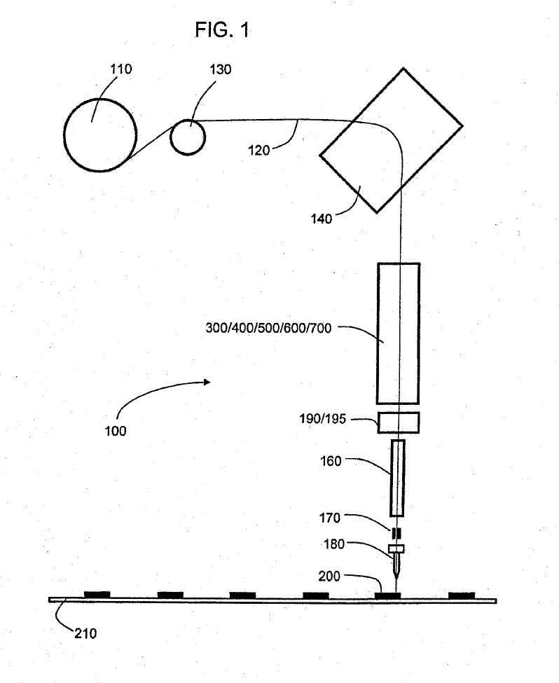

FIG. 1 is a schematic view illustrating a supply mechanism of a wire bonder 100 according to an exemplary embodiment of the present invention.

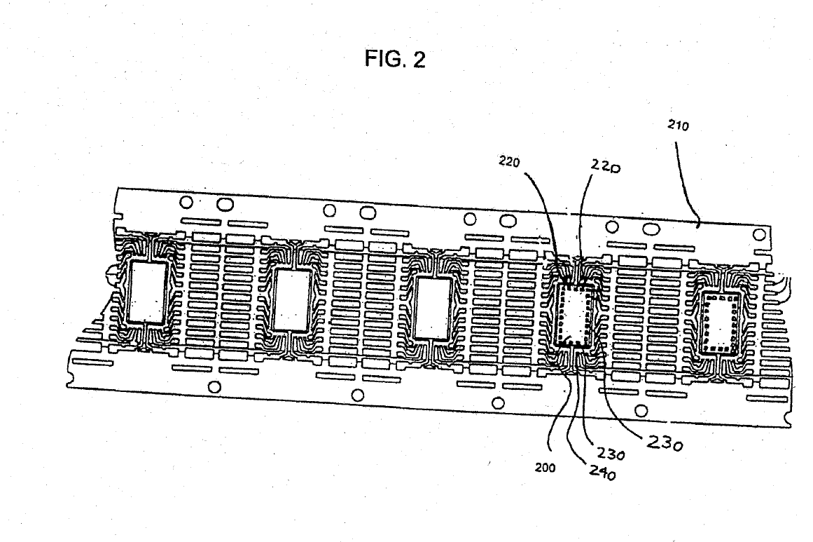

FIG. 2 is a partial top plan view of a semiconductor die 200 and substrate 210 that may be bonded by wire bonder 100.

As shown in FIGS. 1 and 2, wire bonder 100 may be adapted to accept a removable spool 110 of bonding wire 120, and may include a diverter 130, an air guide 140, a cleaning unit (e.g., one or more of cleaning units 300, 400, 500, 600 or 700), a tensioner 160, a wire clamp 170, an electric flame off (EFO) device (not shown), a bonding tool moving unit (not shown), a wire bonding tool 180, a substrate transport unit (not shown), and a compensation unit 190 or 195. Removable spool 110 of bonding wire 120 allows a supply of bonding wire 120 that is spooled around removable spool 110 to be supplied to wire bonding tool 180 via diverter 130, air guide 140, a cleaning unit (e.g., one or more of cleaning units 300, 400, 500, 600 or 700), compensation unit 190 or 195, tensioner 160, and wire clamp 170. That is, bonding wire 120 of a fine size having a diameter less than 100 .mu.m (e.g., between 5 and 100 .mu.m) may be supplied to wire bonding tool 180 for bonding a plurality of bonding wire sections 220 between leadout pads 230 of semiconductor die 200 and corresponding lead connections 240 of substrate 210.

A wire cleaning unit (e.g., one or more of cleaning units 300, 400, 500, 600 or 700) may be integrally mounted on wire bonder 100 and may be disposed in the wire bonding path intermediate to removable spool 110 and wire bonding tool 180 to remove at least a portion of the contaminants (and preferably, substantially all of the contaminants) on the surface of bonding wire 120 prior to bonding wire 120 entering wire bonding tool 180.

Diverter 130 may be provided to change a direction of bonding wire 120 from removable spool 110 toward wire bonding tool 180. Further, air guide 140 may be provided to ensure a smooth and continuous wire supply to wire bonding tool 180. Moreover, tensioner 160 may supply a constant, pre-determined amount of tension to bonding wire 120 during predetermined timeframes of a wire bond cycle. Wire clamp 170 may releasably clamp bonding wire 120 and may be configured to move with wire bonding tool 180, or independent of wire bonding tool 180, to supply bonding wire 120 through wire bonding tool 180 and/or to break bonding wire 120 after the second bond (e.g., a wedge bond) is made.

Bonding wire 120 may be formed from, for example, gold, gold alloy, copper, copper alloy, aluminum or aluminum alloy, among others. Further, a lubricant may be coated over the surface of bonding wire 120 prior to being spooled to prevent bonding wire 120 from sticking with itself on removable spool 110. That is, if the lubricant were not present, atoms in bonding wire 120 from overlapping segments on removable spool 110 that are in close proximity may bond to one another causing bonding wire 120 to prematurely break and undesirably stopping the supply of bonding wire 120 to wire bonding tool 180.

In the exemplary embodiment of the present invention illustrated in FIG. 1, a particular configuration is shown, however, it is contemplated that any number of other configurations having a bonding supply mechanism with some or all of bonding supply components (i.e., diverter 130, air guide 140, cleaning unit 300, 400, 500, 600 or 700, compensation unit 190 or 195, tensioner 160, releasable clamp 170 and wire bonding tool 180) may be provided so long as, if compensation unit 190 or 195 is provided, it is arranged downstream of the cleaning unit (e.g., one or more of cleaning units 300, 400, 500, 600 or 700). Further, it is clear that the present invention includes various embodiments including a cleaning unit without a compensation unit.

Although diverter 130, air guide 140, the cleaning unit (e.g., one or more of cleaning units 300, 400, 500, 600 or 700), and tensioner 160 are illustrated to be in a specific sequential order, it is contemplated that the order of these components may vary. For example, the wire cleaning unit (e.g., one or more of cleaning units 300, 400, 500, 600 or 700) may be operationally disposed anywhere between wire bonding tool 180 and removable spool 110 of bonding wire 120 to remove contamination from bonding wire 120 prior to bonding wire 120 entering wire bonding tool 180.

Wire bonding tool 180 (e.g., a capillary tool) is formed into a hollow shape and bonding wire 120 may be removably inserted through wire bonding tool 180. A ball may be formed at an end of bonding wire 120 that projects from wire bonding tool 180 (e.g., the ball being produced by an EFO device). That is, an EFO device, for example, generates a spark on the end of bonding wire 120 to produce such a ball.

Referring to FIG. 2, after the ball is formed (e.g., by the EFO device), the ball is ball bonded to respective leadout pads 230 of semiconductor die 200. Wire bonding tool 180 is moved by a wire bonding tool moving unit to a location that corresponds to corresponding lead connections 240 of substrate 210, and bonding wire 120 is then wedge bonded to corresponding lead connections 240 of substrate 210. That is, wire bonding tool 180 may be adapted to accept bonding wire 120 from the removable spool 110 of bonding wire 120 and to bond respective bonding wire sections 220 between respective readout pads 230 of semiconductor die 200 and corresponding lead connections 240 of substrate 210.

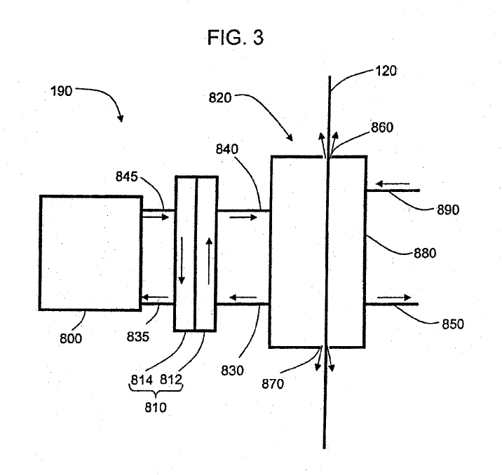

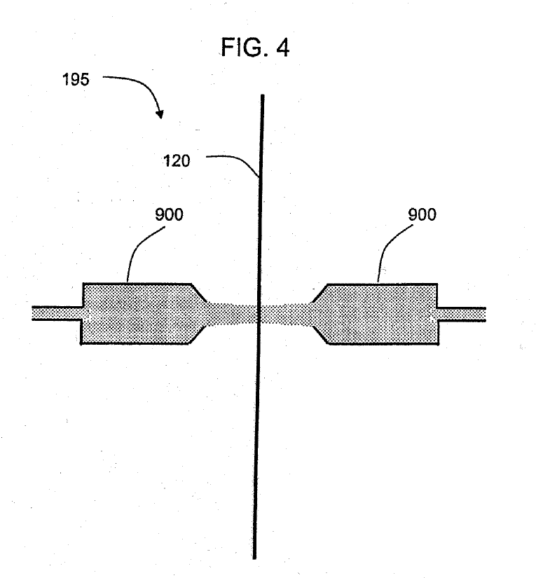

FIGS. 3 and 4 are schematic views illustrating exemplary compensation units 190 and 195, respectively, that may be used with wire bonder 100.

Compensation units 190 or 195, optionally, may be disposed in the bonding wire path downstream of the wire cleaning unit (e.g., one or more of cleaning units 300, 400, 500, 600 or 700) to actively cool bonding wire 120 moving through compensation unit 190 or moving past compensation unit 195 to compensate for heating of bonding wire 120 caused by the wire cleaning unit (e.g., one or more of cleaning units 300, 400, 500, 600 or 700).

As illustrated in FIG. 3, compensation unit 190 may include a cooling unit 800, a heat exchanger 810 and a conditioning unit 820. Conditioning unit 820 may circulate, via heat exchange inlet and outlet ports 830 and 840 and a circulating unit (now shown), a reducing gas or a noble gas between conditioning unit 820 and a conditioning unit side 812 of the heat exchanger 810 to reduce the potential for recontamination of bonding wire 120 after certain contamination is removed by the wire cleaning unit (e.g., one or more of cleaning units 300, 400, 500, 600 or 700). Cooling unit 800 may circulate, via exchange inlet and outlet ports 835 and 845, a cooling gas between cooling unit 800 and a cooling unit side 814 of the heat exchanger 810 to reduce the temperature of the reducing gas or noble gas by heat exchange with the cooling gas.

Conditioning unit 820 may include a chamber 880 configured (1) to allow circulation of a reducing gas (e.g., hydrogen and/or a combination of hydrogen in nitrogen, argon, helium, etc.) or a noble gas (e.g., helium, neon or argon) of a predetermined temperature to actively cool bonding wire 120 after the wire cleaning unit (e.g., one or more of cleaning units 300, 400, 500, 600 or 700) removes contaminants from the surface of bonding wire 120, (2) to provide an environment which is substantially free from contaminants, and/or (3) to prevent contaminants removed from the surface of bonding wire 120 from recombining with the bonding wire 120.

In this configuration, the reducing gas or noble gas may be cycled through chamber 880 to conditioning unit side 812 of heat exchanger 810. In heat exchanger 810, heat may be exchanged between, for example, cooling gas and the reducing gas or noble gas.

Conditioning unit 820 may include a separate outlet port 850 for removing (e.g., purging) the reducing gas or noble gas, although first and second openings 860 and 870 may serve as outlet ports for removing the reducing gas or noble gas from chamber 880.

The conditioning unit 820 may be coupled by a further opening 890 to a gas supply to continuously supply/resupply the reducing gas or noble gas removed/purged through the outlet ports 850, 860 and/or 870.

Although a gas cooling unit is illustrated, it is contemplated that the cooling unit 800 may be any cooling device capable of providing active cooling to remove excess heat from bonding wire 120 to reduce the temperature of bonding wire 120, and may include, for example, a cooling fan, liquid cooling, or a thermoelectric cooling unit, among others.

According to an exemplary embodiment of the present invention, the temperature of bonding wire 120 is substantially the same when leaving compensation unit 190 as it was prior to entry into the wire cleaning unit (e.g., one or more of cleaning units 300, 400, 500, 600 or 700).

As illustrated in FIG. 4, wire bonder 100 may alternatively include compensation unit 195 having one or more nozzle devices 900 configured to blow reducing gas or noble gas of a predetermined temperature across bonding wire 120 to actively cool bonding wire 120 after the wire cleaning unit (e.g., one or more of cleaning units 300, 400, 500, 600 or 700) removes contaminants from the surface of bonding wire 120, and to reduce the potential for contaminants removed from the surface of bonding wire 120 from recontaminating with bonding wire 120. This is accomplished by the reducing gas or the noble gas being sprayed through one or more nozzle devices 900 at bonding wire 120 as bonding wire 120 moves past one or more nozzle devices 900 provided adjacent to the bonding wire path. Thus, the reducing gas or the noble gas may combine with the contamination removed by the wire cleaning unit (e.g., one or more of cleaning units 300, 400, 500, 600 or 700), thereby substantially reducing the potential for recontamination of the bonding wire 120.

Compensation units 190 and 195 illustrated in FIGS. 3-4 are exemplary in nature. Alternative and simpler arrangements (e.g., low velocity forced air or gas) are contemplated for cooling bonding wire cleaned in accordance with the present invention.

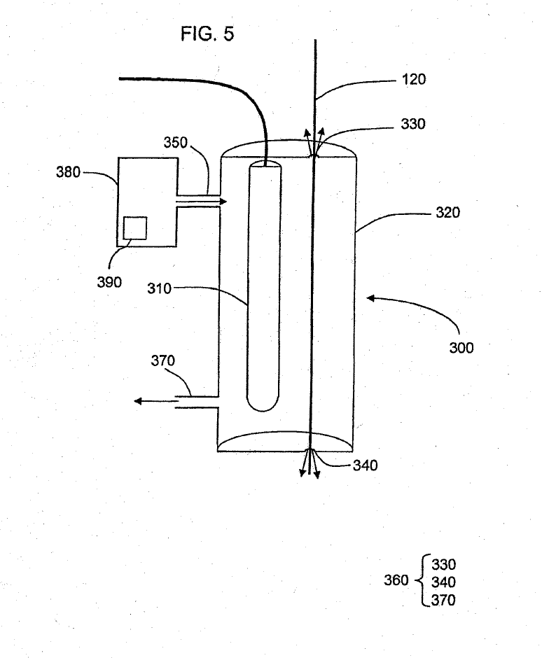

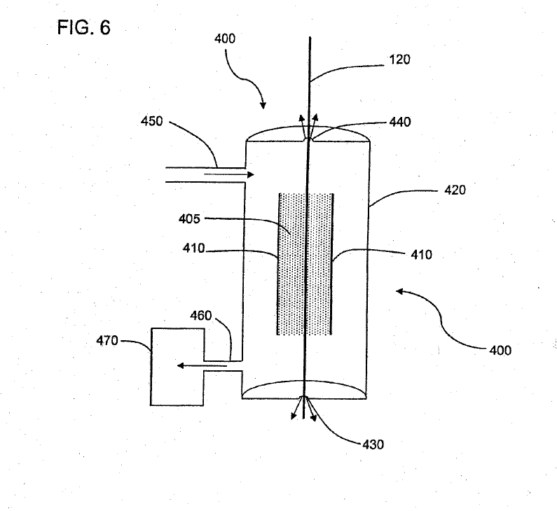

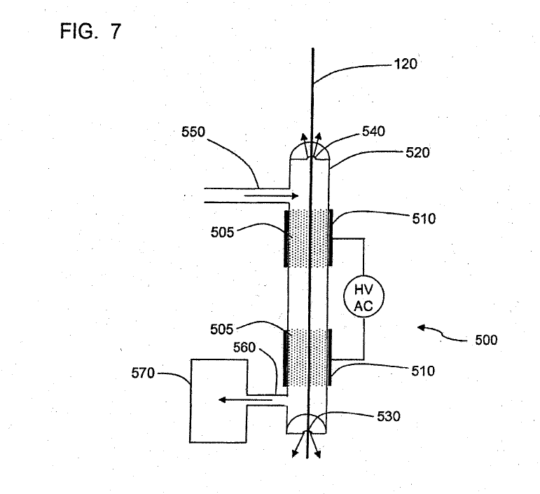

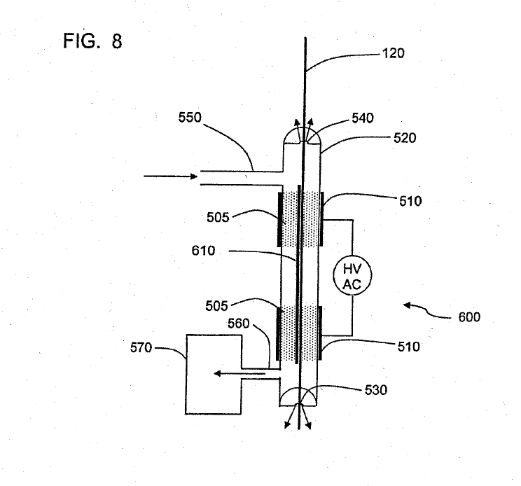

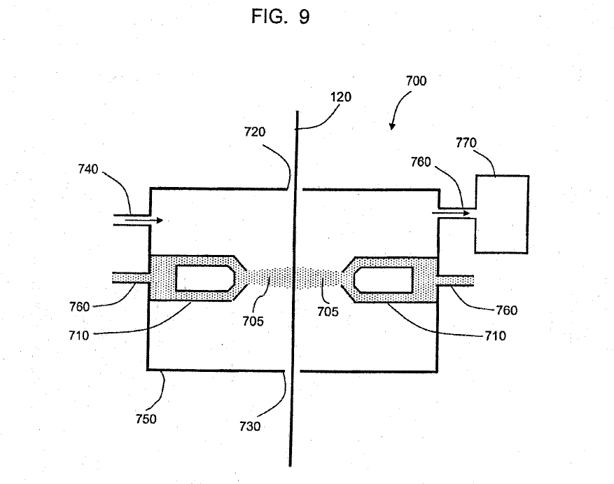

Referring now to FIGS. 5-9, as bonding wire 120 passes through the wire cleaning unit (e.g., one or more of cleaning units 300, 400, 500, 600 or 700) the contaminants (e.g., the lubricant and other contaminants) on the surface of bonding wire 120 are removed by one or more of a combination of ultraviolet light emission unit and ozone generation unit 300 (FIG. 5), a plasma discharge unit 400 (FIG. 6), wire cleaning unit 500 (FIG. 7), wire cleaning unit 600 (FIG. 8), and/or a plasma jet discharge unit 700 (FIG. 9), among others.

FIG. 5 is a schematic view illustrating wire cleaning unit 300 that may be used with wire bonder 100.

Referring to FIG. 5, wire cleaning unit 300 may be configured to accept a light source 310 adapted to emit ultraviolet light (e.g., a UV bulb). Light source 310 may generate ozone based on an interaction of molecular oxygen with the emitted ultraviolet light such that the ultraviolet light and the generated ozone interact with contaminants on the surface of bonding wire 120. The energy imparted by the combination of the emitted ultraviolet light and the generated ozone substantially disassociates (i.e., substantially removes) the contamination from the surface of bonding wire 120.

Wire cleaning unit 300 may include a chamber 320 having first and second openings 330 and 340 such that bonding wire 120 may pass through first and second openings 330 and 340 of chamber 320. Chamber 320 may be formed from a highly reflective material, or chamber 320 may include a highly reflective material on an inside surface thereof. Exemplary reflective materials include aluminum, stainless steel, chrome plating, nickel, nickel plating, and alloys thereof. Further, such reflective materials could be covered by a protective layer (e.g., glass). The reflectivity of the inside of chamber 320 is preferably above 70% or greater. Wire cleaning unit 300 may further include an inlet port 350 to provide a gas mixture to chamber 320 and may include an outlet port 360 to purge the gas mixture from within chamber 320. The gas mixture that may be provided to chamber 320 may include molecular oxygen in a range of about 0% to 50% by weight relative to a weight of the gas mixture.

Outlet port 360 may include first and second openings 330 and 340 to purge the gas mixture from chamber 320 and to allow bonding wire 120 to pass through chamber 320 of wire cleaning unit 300 and/or another opening 370 in chamber 320 to purge the gas mixture.

Wire bonder 100 may further include an ozone providing unit 380 having a separate ozone-generator 390 to generate ozone that may be located on wire bonder 100 such that ozone is supplied into chamber 320 of wire cleaning unit 300 using a carrier gas, such as air, nitrogen, helium and/or argon, among others. The combination of ultraviolet light and ozone is substantially more effective at removing, for example, organic contamination than with ultraviolet light or ozone, individually. By including separate ozone generator 390, higher ozone concentrations may be generated than with ultraviolet light alone to improve the removal of contaminants from bonding wire 120 and to allow a higher throughput of bonding wire 120 through wire cleaning unit 300.

It is preferable that light source 310 be positioned extending along a direction parallel to the path of bonding wire 120. Chamber 320 may be preferably ellipsoid shaped (i.e., elliptical in a plane perpendicular to the path of bonding wire 120) with bonding wire 120 and light source 310 extending along respective axes corresponding to foci of ellipsoid shaped chamber 320. That is, by locating light source 310 at one focus and bonding wire 120 at another focus of the ellipsoid, the amount of light absorbed by bonding wire 120 is increased (e.g., maximized) and due to such a configuration, all portions of the surface of bonding wire 120 may be subjected to ultraviolet light from light source 310 either through direct transmission or via reflection by the highly reflective surface of chamber 320. It is preferred that the ultraviolet light be located in close proximity (e.g., adjacent) to bonding wire 120 without contacting bonding wire 120. Chamber 320 may be purged at a slow flow rate by removing a volume of gas mixture equal to the volume of chamber 320 about every 1 to 300 seconds with air or another gas mixture containing molecular oxygen.

Light source 310 may be capable of generating ozone by interaction with the oxygen, but also may produce wavelengths that may be capable of dissociating ozone to oxygen atoms and molecular oxygen. That is, bonding wire 120 may be simultaneously exposed to ozone, atomic oxygen and ultraviolet light. An ozone removal unit (not shown) for capturing, removing and/or destroying the ozone exiting chamber 320 may be provided adjacent chamber 320, since ozone is a toxic substance and may also have deleterious effects on certain parts of wire bonder 100.

Chamber 320 may be configured to operate at a reduced pressure below about one atmosphere. Chamber 320 may be coupled by the first opening 330, the second opening 340 and/or opening 370 to a vacuum or a vent (not shown) to reduce the pressure in chamber 320 to less than about one atmosphere. The vacuum or venting in conjunction with gas entering at openings 330, 340 and/or opening 350 would establish an equilibrium pressure in chamber 320 at a value below about one atmosphere. In such an embodiment, it is clear that although FIG. 5 illustrates gas leaving openings 330 and 340 (illustrated using directional arrows), gas may be entering these openings.

FIG. 6 is a schematic view illustrating another wire cleaning unit 400 that may be used in wire bonder 100.

Referring to FIG. 6, wire cleaning unit 400 may be configured to generate a plasma 405 between a plurality of electrodes 410, or one or more electrodes 410 and bonding wire 120, by either a direct current or, preferably, an alternating current electric discharge. Preferably, the frequency of this AC discharge is above about 5 kHz, and such AC discharge may also be, for example, in the radio or microwave frequency ranges.

Wire cleaning unit 400 may include a chamber 420 having at least first, second and third openings 430, 440 and 450 such that bonding wire 120 may pass through first and second openings 430 and 440, and third opening 450 may be an inlet port to pass process gas into chamber 420. Wire cleaning unit 400 may further include one or more electrodes 410 that partially or entirely circumferentially surround bonding wire 120 and may be configured with or without bonding wire 120 to generate a plasma discharge in chamber 420 according to potential applied to the plurality of electrodes 410 or the one or more electrodes 410 and bonding wire 120. That is, one electrode 410 may partially or entirely circumferentially surround bonding wire 120 and may be configured with bonding wire 120 to generate a plasma discharge in chamber 420 according to potential applied between one electrode 410 and bonding wire 120. Moreover, plural electrodes 410 may each partially circumferentially surround bonding wire 120 and may be configured with bonding wire 120 to generate a plasma discharge in chamber 420, according to a potential applied between plural electrodes 410 and bonding wire 120. Further, plural electrodes 410 may each partially circumferentially surround bonding wire 120 and may be configured to generate a plasma discharge without bonding wire 120 according to a potential applied between plural electrodes 410. That is, the plasma discharge is generated in the vicinity of bonding wire 120.

The energy imparted by the generated plasma substantially disassociates (i.e., substantially removes) contamination from the surface of bonding wire 120 according to the applied potentials.

One or more electrodes 410 may be arranged inside of chamber 420 with a predetermined gap between the one or more electrodes 410 and bonding wire 120. Such a gap may be predetermined based on the process gas selected and the pressure of the process gas. For example, the higher the process gas pressure, the smaller the predetermined gap.

The process gas may be, for example, i) air, ii) a gas comprising helium, nitrogen, argon and/or oxygen, iii) a gas mixture comprising oxygen in argon, helium, and/or nitrogen, or iv) a gas mixture comprising hydrogen in argon, helium, and/or nitrogen.

For copper or copper alloy bonding wire, a plasma 405 generated by the plasma discharge that includes oxygen may oxidize the surface of bonding wire, while also removing organic contaminants. If contaminants including organic contaminants or copper bonding wire are removed with the plasma 405 that includes oxygen, a second plasma chamber (not shown) including a reducing gas (i.e., one containing, for example, hydrogen and/or a combination of hydrogen in nitrogen) may be used to remove oxidation on the surface of the bonding wire 120. It is preferable that for copper or copper alloy bonding wire, the process gas be hydrogen mixed with any of argon, helium and/or nitrogen to remove surface oxides and other contaminants such as organic contaminants.

Chamber 420 may include a separate outlet port 460 for removing the process gases, although first and second openings 430 and 440 may serve as outlet ports for removing the process gases from chamber 420.

Chamber 420 may be configured to operate at a reduced pressure in a range of about 100 mtorr to about one atmosphere. By reducing pressure in chamber 420 below about one atmosphere, generation of a plasma is enabled at lower voltages. That is, as the pressure in chamber 420 is reduced, the onset of plasma discharge occurs at correspondingly lower voltages. Chamber 420 may be coupled by the first opening 430, the second opening 440 and/or the separate outlet port 460 to a vacuum generator 470 (e.g., a vacuum pump or a venturi) to reduce the pressure in chamber 420 to less than about one atmosphere. The vacuum generator 470 in conjunction with gas entering at openings 430, 440 and optional opening 450 would establish an equilibrium pressure in chamber 420 at a value below about one atmosphere. In such an embodiment, it is clear that although FIG. 6 illustrates gas leaving openings 430 and 440 (illustrated using directional arrows), gas may be entering these openings.

Moreover, a potential of the plasma electrodes 410 and the bonding wire 120 may be controlled to control an interval and/or an intensity of the plasma discharge in chamber 420. It is contemplated that the potential of the plasma electrodes 410 and the bonding wire 120 may be controlled in different periods to control plasma discharge, and in other periods, for example, to allow for testing such as continuity testing of the bond interconnections.

For alternating current electric discharge generated by supplying alternating current potentials to one of the plurality of electrodes 410, or one or more electrodes 410 and bonding wire 120, surfaces of one or more electrodes 410 may include dielectric coatings so that dielectric barrier discharge may occur. That is, each of the one or more electrodes 410 may have a dielectric surface coating.

FIGS. 7 and 8 are schematic views illustrating other wire cleaning units 500 and 600 that may be used in wire bonder 100.

Referring to FIG. 7, wire cleaning unit 500 may be configured to generate a plasma 505 between a plurality of electrodes 510 by an alternating current electric discharge, preferably at a frequency above about 5 kHz, and such AC discharge may also be, for example, in the radio or microwave frequency ranges.

Wire cleaning unit 500 may include a chamber 520 having at least first, second and third openings 530, 540 and 550 such that bonding wire 120 may pass through first and second openings 530 and 540, and third opening 550 may be an inlet port to pass process gas into chamber 520. Wire cleaning unit 500 may further include a plurality of electrodes 510 circumferentially surrounding bonding wire 120 and configured with bonding wire 120 to generate plasma discharges in chamber 520 according to potentials applied to the plurality of electrodes 510 and/or bonding wire 120.

The energy imparted by generated plasma 505 substantially disassociates (i.e., substantially removes) contamination from the surface of bonding wire 120.

One or more electrodes 510 may be arranged either inside or outside of chamber 520 with a predetermined gap between the one or more electrodes 510 and bonding wire 120.

The process gas may be i) air, ii) a gas comprising helium, nitrogen, argon and/or oxygen, iii) a gas mixture comprising oxygen in combination with one or more of helium, argon and/or nitrogen, or iv) a gas mixture comprising hydrogen in combination with one or more of helium, argon and/or nitrogen.

For copper or copper alloy bonding wire, a plasma which includes oxygen may oxidize the surface of the copper or copper alloy bonding wire, while also removing organic contaminants. If contaminants including organic contaminants on copper bonding wire are removed with plasma 505 that includes oxygen, a second plasma chamber (not shown) including a reducing gas (i.e. one containing, for example, hydrogen and/or a combination of hydrogen in nitrogen) may be used to remove oxidation produced in the chamber 520. It is preferable that for copper or copper alloy bonding wire, the process gas be hydrogen mixed with any of argon, helium and/or nitrogen to remove surface oxides and other contaminants such as organic contaminants.

The chamber may include a separate outlet port 560 for removing the process gases, although first and second openings 530 and 540 may serve as the outlet port for removing the process gases from chamber 520.

Chamber 520 may be configured to operate at a reduced pressure in a range of about 100 mtorr to about one atmosphere. In one preferred embodiment, the pressure in the chamber is between about 50 torr and about one atmosphere. By reducing pressure in chamber 520 below one atmosphere, generation of a plasma is enabled at lower voltages. That is, as the pressure in chamber 520 is reduced, the onset of plasma discharge occurs at correspondingly lower voltages. Chamber 520 may be coupled by first opening 530, second opening 540 and/or separate outlet port 560 to a vacuum generator 570 (e.g., a vacuum pump or a venturi) to reduce the pressure in chamber 520 to less than about one atmosphere. The vacuum generator 570 in conjunction with gas entering at openings 530, 540 and optional opening 550 would establish an equilibrium pressure in chamber 520 at a value below about one atmosphere. In such an embodiment, it is clear that although FIG. 7 illustrates gas leaving openings 530 and 540 (illustrated using directional arrows), gas may be entering these openings.

Moreover, a potential of the electrodes 510 and the bonding wire 120 may be controlled to control an interval and/or an intensity of the plasma discharge in chamber 520. It is contemplated that the potential of the electrodes 510 and the bonding wire 120 may be controlled in different periods to control plasma discharge and in other periods, for example, to allow for testing such as continuity testing of the bond interconnections.

For alternating current electric discharge generated by supplying alternating current potentials to the plurality of electrodes 510, surfaces of one or more electrodes 510 may include dielectric coatings so that dielectric barrier discharge may occur. That is, each of the plurality of electrodes 510 may have a dielectric surface coating. Further, chamber 520 may be formed from a dielectric material and the plurality of electrodes 510 may be arranged along an outside surface of chamber 520 circumferentially surrounding chamber 520.

The plurality of electrodes 510 may be shaped as spaced apart rings around the outside of chamber 520 and generate separate plasma zones by applying an alternating current (AC) potential to corresponding sets of ring-shaped electrodes 510. In this case, bonding wire 120 may form a part of an electrical circuit with a corresponding set of ring-shaped electrodes 510. Although only one set of electrodes is shown in the exemplary embodiment illustrated in FIG. 7 any number of sets of electrodes may be provided to generate separate sets of plasma zones.

Elements which are common to the embodiment shown in FIGS. 7 and 8 are omitted for brevity. Referring to FIG. 8, wire cleaning unit 600 may further include a further electrode 610 extending along a direction substantially parallel to an axis of bonding wire 120 and adjacent to bonding wire 120 such that a majority of alternating current generated by plasma discharge conducts through further electrode 610. That is, AC current flows through further electrode 610 rather than through bonding wire 120. This may reduce resistive heating of bonding wire 120 to be cleaned and may reduce electrical noise generated in bonding wire 120.

Referring to FIG. 9, wire cleaning unit 700 may be configured to generate one or more plasma jets 705 from one or more plasma jet devices 710 by either direct current plasma discharges or alternating current plasma discharges. As used herein, a plasma jet device refers to a device which produces a plasma discharge therein and directs the plasma generated by the plasma discharge in a particular direction (i.e., toward bonding wire 120). Generally, the plasma is directed by blowing the plasma in the particular direction.

The plasma jets 705 may be either continuous or pulsed. By using one or more plasma jet devices 710 that provide pulsed plasma jets 705 to bonding wire 120, conductivity test measurements and other measurements of bonding wire 120 may be conducted, when, for example, the plasma jet pulses are not impinging on bonding wire 120. Thus, these measurements may be conducted during periods when noise from the charge built-up from the plasma discharges is reduced or substantially eliminated. Wire cleaning unit 700 may include a chamber 750 having at least first and second openings 720 and 730, and an optional third opening 740, such that bonding wire 120 may pass through first and second openings 720 and 730 and third opening 740 may be an inlet port to pass process gas into chamber 750. Wire cleaning unit 700 may further include one or more plasma jet devices 710, each provided adjacent to bonding wire 120 in a circumferentially spaced apart configuration such that plasma jets 705 from a respective plasma jet device 710 are directed at a portion of bonding wire 120 to generate a plasma discharge at bonding wire 120.

The energy imparted by the generated plasma jets 705 substantially disassociates (i.e., substantially removes) contamination from the surface of bonding wire 120. Process gas used in each of the plasma jet devices 710 to produce the plasma jets may be i) air, ii) a gas comprising helium, nitrogen, argon and/or oxygen, iii) a gas mixture comprising oxygen mixed with helium, argon and/or nitrogen, or iv) a gas mixture comprising hydrogen mixed with helium, argon and/or nitrogen. The process gas is provided to the plasma jet devices 710 via inlet openings 760.

For copper or copper alloy bonding wire, plasma from a plasma jet which includes oxygen may oxidize the surface of bonding wire, while also removing organic contaminants. If contaminants including organic contaminants on copper or copper alloy bonding wire are removed with plasma that includes oxygen, a second plasma chamber (not shown) including a reducing gas (e.g., one containing, for example, hydrogen and/or a combination of hydrogen in nitrogen) may be used to remove oxidation produced in chamber 750.

It is preferable that for copper or copper alloy bonding wire, the process gas be a mixture of hydrogen in argon, helium and/or nitrogen to remove surface oxides and other contaminants such as organic contaminants.

Chamber 750 may include a separate outlet port 760 for removing the process gases, although first and second openings 720 and 730 may serve as outlet ports for removing the process gases from chamber 750.

Chamber 750 may be configured to operate at a reduced pressure in a range of about 100 mtorr to about one atmosphere. By reducing pressure in chamber 750 below about one atmosphere, generation of a plasma is enabled at lower voltages. That is, as the pressure in the chamber is reduced, the onset of plasma discharge occurs at correspondingly lower voltages. Chamber 750 may be coupled by first opening 720, second opening 730 and/or separate outlet port 760 to a vacuum generator 770 (e.g., a vacuum pump or a venturi) to reduce the pressure in chamber 750 to less than about one atmosphere. That is, vacuum generator 770 may communicate with at least one of first opening 720, second opening 730 or separate outlet port 760 to reduce the pressure in chamber 750 to less than about one atmosphere.

One or more plasma jet devices 710 may be arranged inside of chamber 750 with a predetermined gap between each of the one or more plasma jet devices 710 and bonding wire 120.

Although two plasma jet devices 710 are shown in the exemplary embodiment illustrated in FIG. 9, any number of spaced apart plasma jet devices may be provided. It is preferred that all portions of the circumference of bonding wire 120 be directly exposed to the plasma from at least one plasma jet device 710.

The cleaning systems and techniques disclosed herein are applicable to various wire bonding operations (e.g., forward bonding operations, reverse bonding operations) including being applicable to, for example, ball bonding systems and wedge bonding systems.

Although the present invention has been described primarily in relation to bonding wires between a semiconductor die and a leadframe, it is not limited thereto. The present invention is applicable to any of a number of semiconductor devices configured to be wirebonded to any of a number of substrates.

Although the present invention has been described primarily in relation to cleaning of bonding wire, it is not limited thereto. For example, other types of conductive material used in the bonding of semiconductor devices (e.g., dies, chips, etc) are also contemplated as being within the definition of bonding wire, for example, conductive ribbon used in bonding applications.

Further, the cleaning systems and techniques disclosed herein are not limited to the cleaning of bonding wire during the wire bonding process. For example, the cleaning systems and techniques disclosed herein may be used to clean bonding wire during the manufacturing of the wire itself, as opposed to being cleaned in conjunction with the wire bonding operation. Thus, in an application where the wire is to be spooled after being manufactured, the wire may be cleaned using the systems (and according to the techniques) disclosed herein prior to the spooling operation.

Further still, the cleaning systems and techniques disclosed herein may be used to clean a substrate including, but not limited to, the conductive regions of a substrate involved in a wirebonding operation (e.g., the conductive pads on leadframe). Likewise, the cleaning systems and techniques disclosed herein may be used to clean a semiconductor device (e.g., a die, a chip) including, but not limited to, the conductive regions of a such a semiconductor device involved in a wirebonding operation (e.g., the conductive pads on a die).

While preferred embodiments of the invention are illustrated and described herein, it should be understood that such embodiments are provided by way of example only. Numerous variations, changes and substitutions can occur without departing from the scope and spirit of the invention.

1. A wire cleaning system integrated with a wire bonding machine for cleaning wire configured to be wirebonded, the wire cleaning system comprising:
a chamber positioned between a wire spool location on the wire bonding machine and a wire clamp of the wire bonding machine, wherein a wire configured to be wirebonded extends past the wire clamp and through a wire bonding tool prior to the wire being wirebonded; and
an energy source for removing contamination from the wire in the chamber prior to the wire being wirebonded.

2. The wire cleaning system according to claim 1 wherein the energy source includes at least one of an ultraviolet energy source, a light energy source, a plasma discharge energy source, and a plasma jet energy source.

3. The wire cleaning system according to claim 1, further comprising:
a compensation unit disposed downstream of the energy source to cool the wire to compensate for heating of the wire resulting from energy applied by the energy source.

4. The wire cleaning system according to claim 3, wherein the compensation unit comprises a reduction unit to provide a reducing gas to reduce the potential for recontamination of the wire.

5. The wire cleaning system according to claim 1, wherein the energy source is configured to remove at least a portion of a lubricant coating from the wire as the wire passes through the chamber.

6. The wire cleaning system according to claim 1, wherein the energy source includes a light source adapted to emit ultraviolet light to generate ozone based on an interaction of molecular oxygen with the emitted ultraviolet light, and the chamber defines first and second openings such that the wire passes through the first and second openings of the chamber, and the chamber includes a reflective material on an inside surface thereof.

7. The wire cleaning system according to claim 6, wherein the light source is positioned extending along a direction parallel to a path of the wire through the chamber.

8. The wire cleaning system according to claim 6, wherein the chamber is ellipsoid shaped, the wire and the light source extending along respective axes corresponding to foci of the ellipsoid shaped chamber.

9. The wire cleaning system according to claim 1, wherein the chamber defines first, second and third openings such that the wire passes through the first and second openings, and the third opening is an inlet port to admit a gas or a gas mixture; and
the energy source including one or more electrodes circumferentially surrounding the wire and configured with the wire to generate a plasma discharge in the chamber according to a potential applied to the one or more electrodes.

10. The wire cleaning system according to claim 9, wherein the chamber defines an outlet opening, and the wire cleaning system additionally comprising a vacuum pump communicating with at least the outlet opening to reduce pressure in the chamber to less than about one atmosphere.

11. The wire cleaning system according to claim 10, wherein the reduced pressure in the chamber is between about 100 mtorr and about one atmosphere.

12. The wire cleaning system according to claim 9, wherein the potential applied to the one or more electrodes is one of a direct current potential or an alternating current potential, and the one or more electrodes are arranged inside of the chamber with a predetermined gap between the one or more electrodes and the wire.

13. The wire cleaning system according to claim 12, wherein each of the one or more electrodes has a dielectric surface coating thereon.

14. The wire cleaning system according to claim 12, wherein an oscillation frequency of the potential applied to the one or more electrodes is at least about 5 kHz.

15. The wire cleaning system according to claim 12, wherein an oscillation frequency of the potential applied to the one or more electrodes is a radio frequency or a microwave frequency.

16. The wire cleaning system according to claim 9, wherein the chamber is made of a dielectric material and the one or more electrodes are arranged along an outside surface of the chamber.

17. The wire cleaning system according to claim 16, wherein the energy source comprises:
a further electrode extending along a direction parallel to an axis of the wire and adjacent to the wire such that a majority of alternating current generated by the plasma discharge conducts through the further electrode.

18. The wire cleaning system according to claim 1, wherein the chamber defines at least first, second and third openings such that the wire passes through the first and second openings, and the third opening is an inlet port to admit a gas or a gas mixture; and
the energy source includes at least one plasma jet device supplied with a plasma gas and disposed in the chamber adjacent to the wire to generate discharges directed toward the wire.

19. The wire cleaning system according to claim 18, wherein each of the at least one plasma jet device provides a pulsed plasma discharge to remove contaminants from the wire as the wire moves through the chamber.

20. The wire cleaning system according to claim 18, wherein the at least one plasma jet device includes a plurality of plasma jet devices arranged circumferentially around the wire.

21. A wire cleaning system integrated with a wire bonding machine for cleaning wire configured to be wirebonded, the wire cleaning system comprising:
a chamber positioned between a wire spool location on the wire bonding machine and a wire clamp of the wire bonding machine, wherein a wire configured to be wirebonded extends past the wire clamp and through a wire bonding tool prior to the wire being wirebonded; and
an energy source for removing at least one of a lubricant contaminant and an oxide contaminant from the wire in the chamber prior to the wire being wirebonded.

22. The wire cleaning system machine of claim 21 wherein the energy source includes at least one of an ultraviolet energy source, a light energy source, a plasma discharge energy source, and a plasma jet energy source.

23. A wire bonding machine comprising:
a wire bonding tool configured to receive a wire to be bonded to a location; and
a wire cleaning system for cleaning the wire prior to the wire being bonded to the location, the wire cleaning system including: (1) a chamber through which the wire extends prior to the wire being bonded to the location, and (2) an energy source for removing contamination from the wire in the chamber prior to the wire being bonded to the location, the chamber being positioned between a wire spool location of the wire bonding machine and a wire clamp of the wire bonding machine.

24. The wire bonding machine of claim 23 wherein the energy source includes at least one of an ultraviolet energy source, a light energy source, a plasma discharge energy source, and a plasma jet energy source.

25. A method of bonding a wire between a conductive pad of a semiconductor device and a conductive pad of a substrate, the method comprising the steps of:
removing contamination from the wire prior to bonding the wire between the conductive pad of the semiconductor device and the conductive pad of the substrate using a contamination removal system integrated with a wire bonding machine, the contamination removal system including: (1) a chamber through which the wire extends prior to the wire being bonded, and (2) an energy source for removing contamination from the wire in the chamber prior to the wire being bonded, the chamber being positioned between a wire spool location of the wire bonding machine and a wire clamp of the wire bonding machine; and
bonding the wire between the conductive pad of the semiconductor device and the conductive pad of the substrate.

26. The method according to claim 25, further comprising the step of:
cooling the wire to compensate for heating of the wire caused by the removing step.

27. The method according to claim 25, further comprising the step of:
providing a reducing gas in a vicinity of the wire to reduce the potential of recontamination of the wire after the removing step.

28. The method according to claim 25, wherein the removing step includes removing contamination from the wire using at least one of i) plasma discharge cleaning, ii) ultraviolet light emissions and ozone cleaning or iii) plasma jet discharge cleaning.

29. The method according to claim 25, wherein the removing step includes removing contamination from the wire using the energy source, wherein the energy source includes at least one of an ultraviolet energy source, a light energy source, a plasma discharge energy source, and a plasma jet energy source.

30. The method according to claim 25, wherein the removing step includes removing at least one of a lubricant contaminant and an oxide contaminant from the wire in the chamber.
